(19) United States
(12) Patent Application Publication
(10) Pub. No.: US 2018/0258959 A1
(43) Pub. Date: Sep. 13, 2018

(54) Vaned Diffuser and Blower, Fluid Machine, or Electric Blower Provided with Same

(71) Applicant: Hitachi, Ltd., Chiyoda-ku, Tokyo (JP)

(72) Inventors: Takeshi HONDA, Tokyo (JP); Koma SATO, Tokyo (JP)

(21) Appl. No.: 15/754,829

(22) PCT Filed: Aug. 26, 2015
(86) PCT No.: PCT/JP2015/073925

§ 371 Date: Feb. 23, 2018

(51) Int. Cl. F04D 29/66; F04D 29/60; F04D 29/44; F04D 29/42

(52) U.S. Cl. CPC F04D 29/665; F04D 29/60; F05D 2260/96; F04D 29/4213; F05D 2250/52; F04D 29/444

(57) ABSTRACT

Provided are a vaned diffuser and a blower, fluid machine, or electric blower provided with the same, which can achieve both low noise and high efficiency by suppressing mixing loss of standing waves occurring in overlapping sections formed by diffuser vanes, and the main flow in the overlapping sections. The vaned diffuser includes a partition plate, a plurality of vanes provided on one surface side of the partition plate, and a plurality of overlapping sections formed to be sandwiched between the partition plate and adjacent vanes among the plurality of vanes. The partition plate has two holes in a direction orthogonal to each of the overlapping sections, and is provided with a flow path that connects a hole on the inner side in the radial direction among the two holes with a hole on the outer side in the radial direction among the two holes in the adjacent overlapping section.

### TECHNICAL FIELD

The present invention relates to a vaned diffuser and a blower, fluid machine, or electric blower provided with the same.

### BACKGROUND ART

Background art in the present technical field includes, for example, Japanese Patent No. 4729599 (Patent Literature 1). Patent Literature 1 discloses a structure in which, in order to reduce noise of a blower and achieve an improvement in efficiency of the blower, an overlapping section is formed to be sandwiched between adjacent diffuser blades, and a through-hole erecting from a partition plate is formed in a part of one diffuser blade in an air flow path of the overlapping section, the part lying between an outlet end face of the other diffuser blade and a position to which an opening end correction is added. The structure disclosed in Patent Literature 1 is adapted to suppress standing waves with the outlet of the overlapping section being an opening end, in the air flow path (hereinafter also referred to as overlapping section) formed by the adjacent diffuser blades (hereinafter also referred to as diffuser vanes).

### CITATION LIST

### Patent Literature

Patent Literature 1: Japanese Patent No. 4729599

### SUMMARY OF INVENTION

### Technical Problem

A vaned diffuser having overlapping sections has a problem in that standing waves occurring in the overlapping sections cause noise to be increased at a predetermined operational speed of revolution. Moreover, the structure having through-holes provided in the vanes as described in Patent Literature 1 reduces noise of a blower and achieves an improvement in efficiency of the blower, but poses problems such that: a pressure difference between the adjacent overlapping sections connected through the through-holes is large to allow a flow to occur in the through-holes provided in the vanes; and the flow blown from the through-holes is mixed with the main flow in the overlapping sections, thereby leading to occurrence of loss and obstruction to an improvement in efficiency.

That is, problems to be solved for achieving both low noise and high efficiency are suppression of the standing waves occurring in the overlapping sections, and suppression of the mixing loss of the flow blown from the through-holes provided for suppressing the standing waves, and the main flow in the overlapping sections.

It is therefore an object of the present invention to provide a vaned diffuser and a fluid machine, or an electric blower provided with the same, which achieves both low noise and high efficiency by suppressing mixing loss of standing waves occurring in overlapping sections formed by diffuser vanes, and the main flow in the overlapping sections.

### Solution to Problem

In order to achieve the above object, configurations described in the claims are adopted.

The present invention provides a number of solutions to the above problems, and a vaned diffuser reflecting one aspect of the present invention includes: a partition plate; a plurality of vanes provided on one surface side of the partition plate; and a plurality of overlapping sections each formed to be sandwiched between the partition plate and adjacent vanes among the plurality of vanes, wherein the partition plate has two holes in a direction orthogonal to each of the overlapping sections, and is provided with a connection flow path that connects a hole on an inner side in a radial direction among the two holes with a hole on an outer side in the radial direction among the two holes in an adjacent overlapping section.

### Advantageous Effects of Invention

The present invention makes it possible to provide a vaned diffuser and a fluid machine, or an electric blower provided with the same, which achieves both low noise and high efficiency by suppressing mixing loss of standing waves occurring in overlapping sections formed by diffuser vanes, and the main flow in the overlapping sections.

### BRIEF DESCRIPTION OF DRAWINGS

FIG. 1 is a schematic cross-sectional view of a fluid machine having a vaned diffuser.

FIG. 2 is a schematic view of a blower according to a first embodiment.

FIG. 3 is a cross-sectional view of the blower according to the first embodiment.

FIG. 4 is a schematic view of a connection flow path constituted by a channel, according to the first embodiment.

FIG. 5 is a diagram showing comparison of noise levels with respect to a ratio of a length of the connection flow path to a length of an overlapping section.

FIG. 6 is a schematic view of a blower according to a second embodiment.

FIG. 7 is a diagram showing comparison of noise levels with respect to presence or absence of a connection flow path according to the second embodiment.

FIG. 8 is a longitudinal section view of an electric blower.

### DESCRIPTION OF EMBODIMENTS

Hereinafter, a first embodiment and a second embodiment of the present invention will be described in detail based on the accompanying drawings.

### First Embodiment

An embodiment of the present invention will be hereinafter described with reference to the drawings.

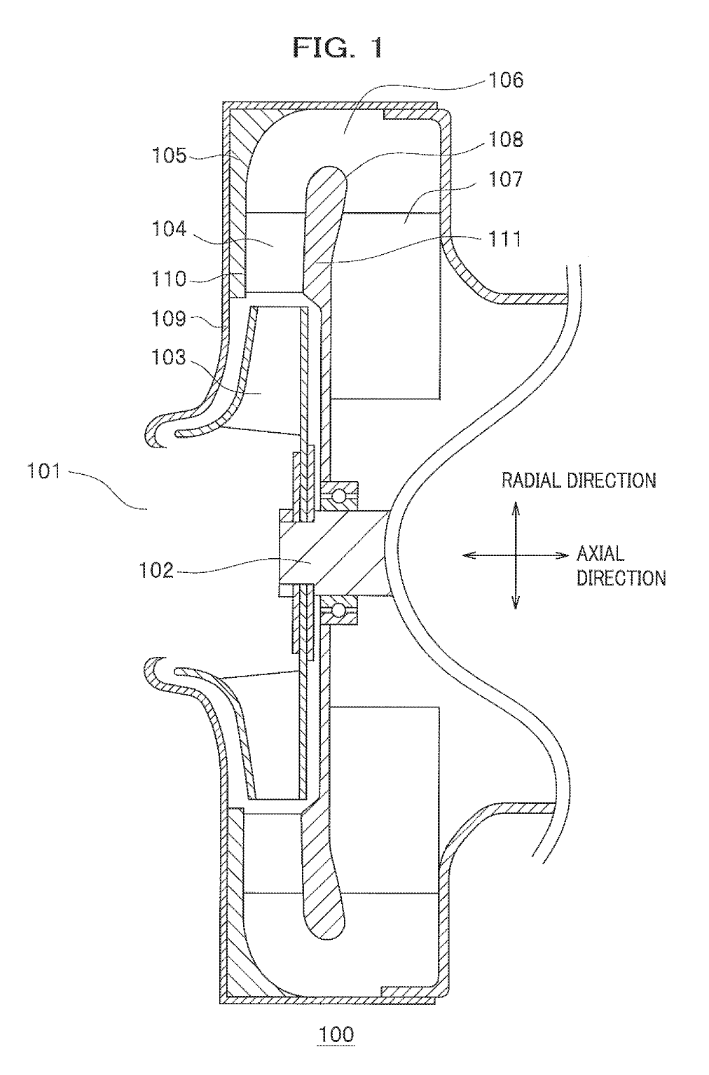

First, a typical centrifugal fluid machine will be described with reference to FIG. 1. FIG. 1 shows a schematic cross-sectional structure of a fluid machine having a vaned diffuser. In a fluid machine 100, a length direction of a rotating shaft 102 of a motor is defined as an axial direction, and a direction orthogonal to the length direction is defined as a radial direction.

The fluid machine 100 has an impeller 103 mounted on the rotating shaft 102 of the motor, and a vaned diffuser 104 disposed on an outer circumferential side of the impeller 103. Provided on the vaned diffuser 104 are a ring 105 that suppresses leak to a shroud 110 side, and a partition plate 108 that forms a hub 111. A return flow path 106 is formed downstream of the vaned diffuser 104. The return flow path 106 is formed by a casing 109 that covers the ring 105 and the diffuser, and the partition plate 108. The return flow path 106 is adapted to turn a flow path directed outwardly in the radial direction to the inside. A return guide 107 is provided downstream of the return flow path 106.

Next, description will be given of a flow of fluid in the fluid machine 100. Rotation of the impeller 103 causes fluid to flow in through a suction port 101, and the fluid is increased in pressure by the impeller 103 and then flows into the inside of the vaned diffuser 104. The vaned diffuser 104 reduces a flow velocity of the fluid flown out from the impeller 103, thereby increasing a static pressure. The flow passing through the vaned diffuser 104 is turned by the return flow path 106 from an outward flow in the radial direction to an inward flow. Then, the flow passing through the return flow path 106 is decreased in a tangential velocity in a rotation direction thereof by the return guide 107, and introduced to the downstream side to be then discharged through a predetermined outlet.

Note that, on the downstream side of the return guide 107, a motor flow path such as a conventional electric blower may be constructed or an impeller different from the illustrated impeller 103 may be provided. Moreover, the impeller 103 in FIG. 1 shows a closed impeller having a shroud board, but may be an open impeller having no shroud board. Furthermore, the vaned diffuser 104 is not configured to be in contact with the casing 109 through the ring 105, but may be configured to be in direct contact with the casing 109.

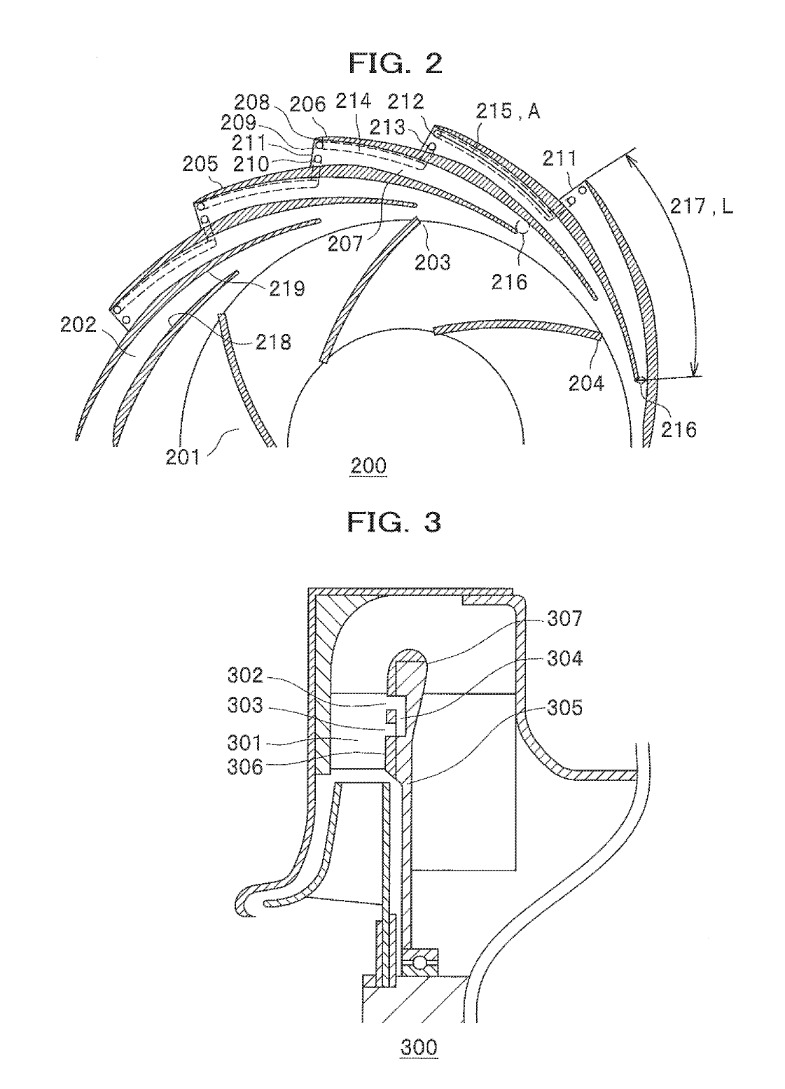

Next, description will be given of a blower 200 in FIG. 2. As a typical example, FIG. 2 illustrates an impeller 201 and a vaned diffuser 202. The impeller 201 is composed of a plurality of impeller vanes 203, 204. The vaned diffuser 202 has a plurality of diffuser vanes 205, 206 which form overlapping sections 207. Note that the present embodiment shows a configuration in which, when the number of the impeller vanes is expressed as Zi and the number of the diffuser vanes is expressed as Zd, an angle between the impeller vanes: 360/Zi lies in a range of 0.9×2×360/Zd or more and 1.1×3×360/Zd or less. Note that, as a typical example, FIG. 2 illustrates the case where the number Zi of the impeller vanes is eight and the number Zd of the diffuser vanes is fifteen.

Moreover, description will be given of representative various factors of the fluid machine to which the present invention is directed. An impeller outer diameter of the fluid machine used in the present invention lies in a range of approximately 20 mm to 400 mm; a height of the outlet of the vane lies in a range of approximately 3 to 12 mm; and the maximum speed of revolution lies in a range of approximately 20000 to 150000 revolutions per minute.

The overlapping section 207 is a section formed by adjacent diffuser vanes 205, 206 and the partition plate, which extends from an inlet throat part 216 of the diffuser to an outlet 211 of the overlapping section, the outlet lying on a line orthogonal to an inner shape of a following edge 208 of the diffuser vane 206. Moreover, a length 217, L of the overlapping section is defined by the length of a line which, when drawing circles nearly tangent to the diffuser vane along the shape of the overlapping section 207, passes through the center of each circle. Moreover, when a tapered part or a rounded part is provided on the following edge 208, the outermost diameter of the overlapping section not including the tapered or rounded part may be defined as a position of the following edge. Note that, among the vane surfaces in the overlapping sections, a vane surface located on the inner side in the radial direction is defined as an acting face 218, and a vane surface located on the outer side in the radial direction is defined as a suction surface 219. Moreover, in the overlapping section, standing waves occur with the outlet 211 of the overlapping section being an opening end, thus causing a problem in that noise is increased at a predetermined operational speed of revolution.

For suppression of the standing waves and suppression of the mixing loss of the main flow in the overlapping sections, the fluid machine according to the present embodiment is configured to provide: two holes 209, 210 near the outlet 211 of one overlapping section in the partition plate and nearly parallel to the outlet 211 of the one overlapping section; two holes 212, 213 near the outlet of the overlapping section adjacent to the one overlapping section in the partition plate; and a connection flow path 214 that connects the hole 209 on the outer side in the radial direction with the overlapping section adjoining frontward in the rotation direction, and the hole 213 on the inner side in the radial direction. The two holes 209, 210 provided nearly parallel to the outlet 211 of the overlapping section are located at places nearly orthogonal to the flow path of the overlapping section. In the flow path of the overlapping section, static pressures at the two holes 209, 210 are nearly the same as each other, and thus a difference between flow velocities around the two holes 209, 210 is small. That is, also in each of different overlapping sections such as the adjacent overlapping sections, static pressures at the two holes are nearly the same as each other. In other words, static pressures at the holes 209, 210, 212, 213 are nearly the same as one another. Since the static pressures are nearly the same, the flow velocity in the connection flow path 214 connecting the hole 209 with the hole 213 is low. Since the flow velocity of air flowing in the connection flow path 214 is low, the mixing loss of the flow path flowing in the connection flow path 214 and the flow path (the main flow) flowing in the overlapping sections is not so great and negligible. Note that a width of the connection flow path 214 connecting the two holes 209, 213 with each other is nearly the same as a diameter of each hole and is a nearly constant width.

Moreover, a length 215, A of the connection flow path 214 is defined by the length of a line which, when drawing circles nearly tangent to the diffuser vane along the shape of the connection flow path, passes through the center of each circle. Note that the size of the hole may be set to be smaller than the width of the connection flow path. Setting the size of the hole to be smaller makes it possible to further reduce the mixing loss of the main flow. Moreover, as long as the two holes provided in the overlapping section are located at places nearly orthogonal to the flow path of the overlapping section, they may be arranged at a place between ½ the length L of the overlapping section and the outlet 211 of the overlapping section, not near the outlet 211 of the overlapping section. The reason for that the two holes may be arranged at a place between ½ the length L of the overlapping section and the outlet 211 of the overlapping section is because the standing waves in the overlapping section are subjected to a great pressure fluctuation in a rear section of the overlapping section. Moreover, since the place between ½ the length L of the overlapping section and the outlet 211 of the overlapping section is a place where a change in the flow velocity in each flow path of the overlapping sections becomes small, static pressures at the holes in each flow path become nearly the same as each other and thus the mixing loss of the main flow does not become so great.

Next, FIG. 3 shows a cross-sectional structure of a machine into which the blower in FIG. 2 is incorporated. The machine shown in FIG. 3 is configured to provide two holes 302, 303 in a hub-side partition plate 306 of a vaned diffuser 301, and a connection flow path 304 that connects adjacent overlapping sections with each other. Note that the diffuser is configured to allow the diffuser vane 301 and the hub-side partition plate 306 to be one body. Moreover, the connection flow path 304 is configured to allow a part on the return guide side of the partition plate 306 and a return guide-side partition plate 305 in which a part of the connection flow path 304 is included as a channel structure, to be combined together. Further, the part composing the diffuser vane 301 and the return guide-side partition plate 305 form a fitting structure 307 by which the center and positions in the circumferential direction thereof are determined, and are stuck together by welding or bonding, or employ a leak prevention structure using O-rings, so as not to allow the flow in the connection flow path to leak into sections other than the section between the diffuser vanes. Note that, when the connection flow path is configured, an inside radius of curvature of the return flow path becomes large and thus separation occurring in the return flow path can be suppressed. Moreover, the connection flow path may be composed of a flow path employing a pipe or a tube. Note that the holes provided at the outlet of the overlapping section may be provided in the ring of the diffuser and the connection flow path may be provided in the casing. Moreover, the vaned diffuser may be of a centrifugal type or of a mixed flow type.

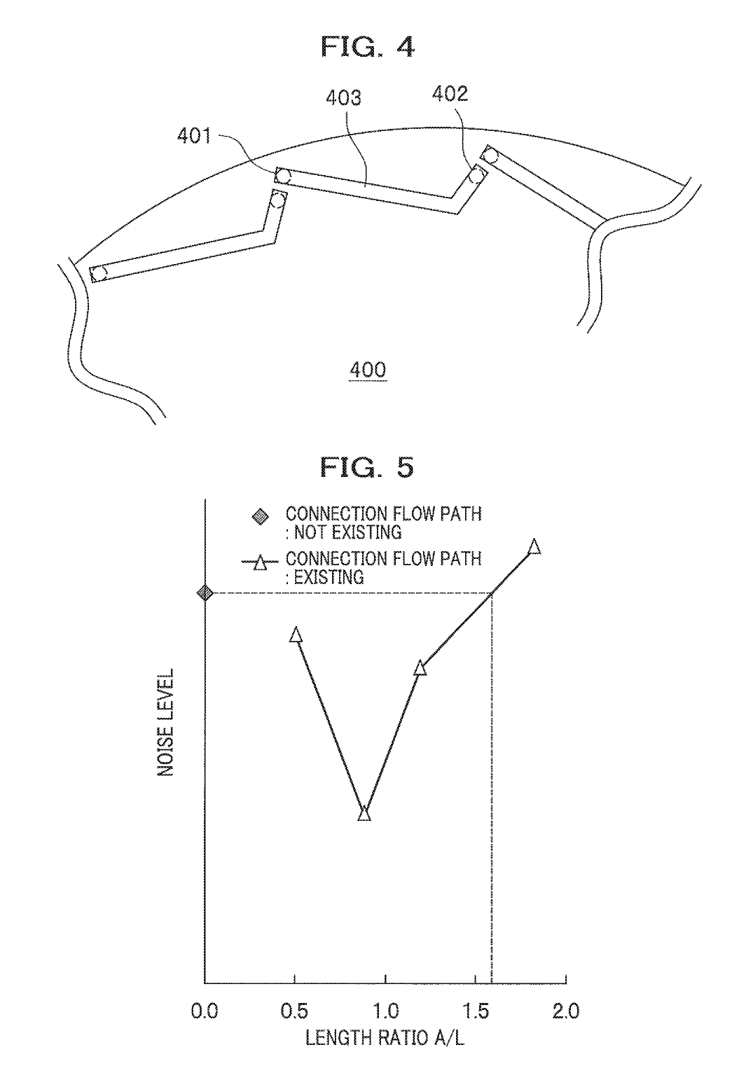

FIG. 4 shows illustration of a return guide-side partition plate 400 to which the return guide-side partition plate 305 shown in FIG. 3 is changed. The return guide-side partition plate 400 has a channel 403 provided to connect a hole 401 on the outer side in the radial direction with an overlapping section adjoining frontward in the rotation direction, and a hole 402 on the inner side in the radial direction.

Next, FIG. 5 shows results of comparison of noise levels with respect to a ratio of the length A of the connection flow path to the length L of the overlapping section. Note that the results of comparison are acoustic analytic results obtained when a point sound source for each frequency is placed at the outlet of the impeller.

From FIG. 5, when the connection flow path is not provided (not existing), it is understood that the noise level is relatively high because resonance is caused by the standing waves in the overlapping section. On the other hand, when the connection flow path is provided (existing), it is understood that the noise level is relatively low where the length ratio A/L is smaller than 1.5. Moreover, it is understood that the length ratio A/L of the connection flow path to the overlapping section is preferably approximately 1.0. This is because a phase of sound waves in the connection flow path and a phase of sound waves in the overlapping section become opposite to each other and thus the most suitable range exists in which the standing waves can be mutually canceled. Note that a minimum length of the connection flow path is related to a length of the outlet of the adjacent overlapping section, and where the length ratio A/L is smaller than 0.5, the connection flow path comes short of the required length even if it is linearly configured, thus making the configuration difficult. Moreover, where the connection flow path is provided which connects the adjacent overlapping sections with each other, the phase of sound waves in the connection flow path becomes close to the phase of sound waves in the adjacent overlapping sections in the range of the length ratio A/L being larger than 1.5, thus increasing the noise. Further, when the length ratio A/L is set to be larger than 1.5, the channel structure in the return guide-side partition plate 305 becomes complicated. When the channel structure becomes complicated, the partition plate becomes filled with channels by lengthening the connection flow path where it is made of resin, and the partition plate becomes uneven in thickness (also becomes thin), allowing sink marks to exist. Consequently, there is a risk that flow of the resin during molding becomes difficult, and a risk that working hours during cutting and manufacturing are increased to increase a manufacturing cost. In other words, the most suitable value exists in the length A of the connection flow path in relationship with the length L of the overlapping section, and when the length ratio A/L is set to be approximately 1.0, low noise can be achieved without increasing a manufacturing cost.

That is, the configuration according to the present embodiment allows the pressures at the two holes provided in each of the overlapping sections to be nearly the same as each other, and allows the connection flow path that connects the holes in the adjacent overlapping sections with each other, to be provided, thereby making it possible: to suppress the mixing loss of the main flow in the overlapping sections and thus to prevent a decrease in efficiency; and, where the length ratio A/L of the length A of the connection flow path to the length L of the overlapping section is equal to or larger than 0.5 and smaller than 1.5, to suppress the standing waves in the overlapping sections through the connection flow path and thus to achieve a reduction in noise.

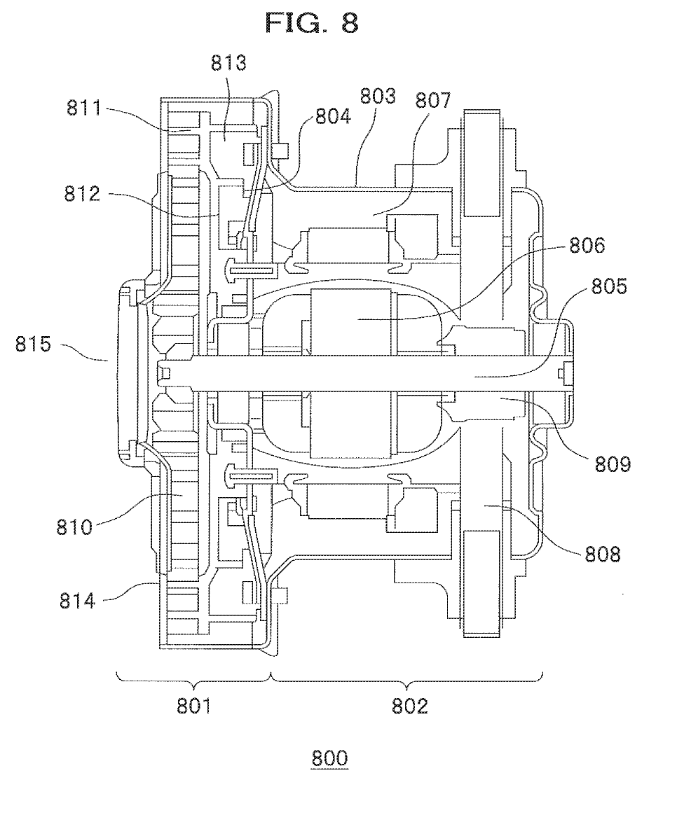

Here, description is given of configuration of an electric blower 800 with reference to FIG. 8. FIG. 8 is a longitudinal section view of the electric blower 800. The electric blower 800 is composed of a blower 801 and an electric motor 802.

The electric motor 802 has a motor shell which is composed of a housing 803 having an opening at one end thereof, and of an end bracket 804 disposed on the opening side of the housing 803. A rotating shaft 805 of a rotor 806 is rotatably supported by the side opposite to the opening side of the housing 803 and the end bracket 804, and the rotor 806 is mounted on the rotating shaft 805. The electric motor 802 is configured to have a stator 807 disposed on an outer circumferential side of the rotor 806. Supply of electricity to the rotor 806 is carried out through a brush 808 and a commutator 809 in contact with the brush 808. The housing 803 allows the rotor 806, the stator 807 and the brush 808 to be housed therein.

The blower 801 is configured to allow an impeller 810 provided with an inlet 815, a diffuser 811 disposed on an outer circumferential side of the impeller 810, and a return guide 813 disposed opposite to the diffuser 811 with a partition plate 812 between the diffuser 811 and the return guide 813, to be housed in a fan casing 814. The fan casing 814 is disposed on the opening side of the housing 803 and covers the impeller 810, the diffuser 811 and the return guide 813. The partition plate 812 is located at a back surface side (opposite side of the inlet) of the impeller 810. The diffuser 811 is disposed at a front surface side of the partition plate 812, and the return guide 813 is disposed at a rear surface side of the partition plate 812.

In this configuration, air flown in through the inlet 815 of the electric blower is first increased in pressure and increased in velocity by the impeller 810. Thereafter, the flow passing through the diffuser 811 is turned approximately 180 degrees through a bent flow path and flown into the return guide 813. In this process, the flow is decreased in velocity and increased in pressure accordingly. The flow passing through the return guide 813 is flown into the housing 803 of the electric motor, and cools the rotor 806, the stator 807, the brush 808, the commutator 809 and the like, to be then discharged.

When the electric blower shown in FIG. 8 used in a vacuum cleaner is equipped with the vaned diffuser having the configuration according to the present embodiment, the pressures at the two holes provided at the outlet of the overlapping section are nearly the same as each other, thus making it possible to suppress the mixing loss of the main flow in the overlapping sections and to suppress the standing waves in the overlapping sections through the connection flow path, thereby achieving high efficiency and low noise in a wide range of the operational speed of revolution.

### Second Embodiment

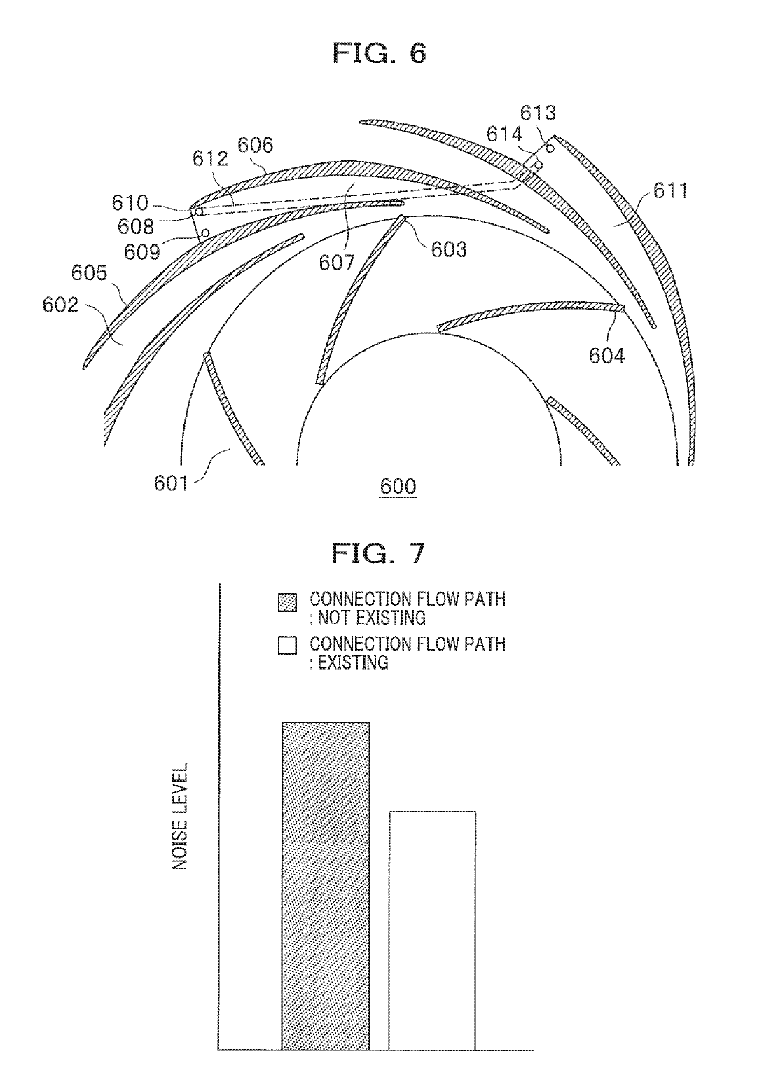

Next, configuration of a blower 600 according to a second embodiment will be described with reference to FIG. 6. Since the configuration is basically the same as that in the first embodiment, the same component is given the same reference sign and thus description thereof is omitted. Here, description will be given of the blower 600 with attention being paid to the blower 300 shown in FIG. 3.

The blower 600 is configured in the same way as in the blower in FIG. 2: an impeller 601 is composed of a plurality of impeller vanes 603, 604; and a vaned diffuser 602 has a plurality of diffuser vanes 605, 606 which form overlapping sections 607. Note that, as a typical example, FIG. 6 illustrates the case where the number Zi of the impeller vanes is eight and the number Zd of the diffuser vanes is eleven. Note that definition of the overlapping sections is the same as that in the first embodiment.

For suppression of the standing waves occurring in the overlapping sections, the fluid machine according to the present embodiment is configured to provide: two holes 608, 609, or 613, 614 near an outlet 610 of each of every other overlapping sections and nearly parallel to the outlet of the overlapping section; and a connection flow path 612 that connects the hole 608 on the outer side in the radial direction with the every other overlapping section 611 adjoining frontward in the rotation direction, and the hole 614 on the inner side in the radial direction. The two holes provided nearly parallel to the outlet 610 of the overlapping section are located at places nearly orthogonal to the flow path of the overlapping section. In the flow path of the overlapping section, static pressures at the two holes are nearly the same as each other, and thus a difference between flow velocities around the two holes is small. That is, also in each of different overlapping sections, static pressures at the two holes are nearly the same as each other. Therefore, the flow velocity in the connection flow path 612 is low and thus the mixing loss of the main flow in the overlapping sections is negligible. Note that a width of the connection flow path 612 connecting the two holes with each other is nearly the same as a diameter of each hole and is a nearly constant width. Moreover, the size of the hole may be set to be smaller than the width of the connection flow path. Further, the two holes provided in the overlapping section may be arranged to be nearly orthogonal to the flow path of the overlapping section and at a place between ½ the length L (see FIG. 2) of the overlapping section and the outlet 610 of the overlapping section. Note that a cross-sectional structure of a machine into which the blower in FIG. 6 is incorporated is nearly the same as that in FIG. 3, and a structure of the return guide-side partition plate is nearly the same as that in FIG. 4, and thus description thereof is omitted.

Next, FIG. 7 shows results of comparison of noise levels with respect to presence or absence of the connection flow path described in the second embodiment. Note that the results of comparison are acoustic analytic results obtained when a point sound source for each frequency is placed at the outlet of the impeller. When the connection flow path is not provided (not existing), the noise level is relatively high because resonance is caused by the standing waves in the overlapping section. On the other hand, when the connection flow path is provided (existing), it is understood that the noise level is relatively low. In the second embodiment, the connection flow path connects between the adjoining every other overlapping sections to allow the length A (see FIG. 2) of the connection flow path to become longer than the length L of the overlapping section, resulting in the length ratio A/L being 2 or more. Moreover, the connection flow path is configured to connect between the adjoining every other overlapping sections, thereby allowing a length of the connection flow path to be lengthened, for which the phase of sound waves in the overlapping section exhibits an opposite phase. Therefore, even when the length ratio A/L is 2 or more, low noise can be achieved. Further, when connecting the adjoining every other overlapping sections, the connection flow path can be configured nearly linearly and thus the channel structure in the return guide-side partition plate becomes simplified. Accordingly, for example, where the partition plate is made of resin, a risk that flow of the resin during molding becomes difficult, and a risk that working hours during cutting and manufacturing are increased to increase a manufacturing cost, can be avoided.

Noise reducing effect in the case of the connection flow path existing is the same as that in the first embodiment, which is because the phase of sound waves in the connection flow path and the phase of sound waves in the overlapping section become opposite to each other, thereby mutually canceling the standing waves. That is, since the pressures at the two holes provided at the outlet of the overlapping section are nearly the same as each other, the mixing loss of the main flow in the overlapping sections can be suppressed and the standing waves in the overlapping sections can be suppressed through the connection flow path, thereby making it possible to achieve both high efficiency and low noise.

Moreover, when the electric blower used in a vacuum cleaner is equipped with the vaned diffuser having the configuration according to the present embodiment, the pressures at the two holes provided at the outlet of the overlapping section are nearly the same as each other, thus making it possible to suppress the mixing loss of the main flow in the overlapping sections and to suppress the standing waves in the overlapping sections through the connection flow path, thereby achieving high efficiency and low noise in a wide range of the operational speed of revolution.

### REFERENCE SIGNS LIST

100 Fluid machine
101 Suction port
102 Rotating shaft
103, 201, 601, 810 Impeller
104, 202, 602, 811 Vaned diffuser
105 Ring
106 Return flow path
107, 813 Return guide
108, 812 Partition plate
109, 814 Casing
110 Shroud
111 Hub
200, 300, 600, 801 Blower
203, 204, 603, 604 Impeller vane
205, 206, 301, 605, 606 Diffuser vane
207, 607 Overlapping section
208 Following edge of diffuser vane
209, 212, 302, 401, 608, 613 Hole on outer side in radial direction
210, 213, 303, 402, 609, 614 Hole on inner side in radial direction
211, 610 Outlet of overlapping section
214, 304, 612 Connection flow path
215 Length of connection flow path
216 Inlet throat part
217 Length of overlapping section
218 Acting face
219 Suction surface
305, 400 Return guide-side partition plate
306 Hub-side partition plate
403 Channel
611 Every other overlapping section
800 Electric blower
802 Electric motor
803 Housing
804 End bracket
805 Rotating shaft
806 Rotor
807 Stator
808 Brush
809 Commutator
815 Inlet of electric blower

1. A vaned diffuser comprising:
a partition plate;
a plurality of vanes provided on one surface side of the partition plate; and
a plurality of overlapping sections each formed to be sandwiched between the partition plate and adjacent vanes among the plurality of vanes, wherein
the partition plate has two holes in a direction orthogonal to each of the overlapping sections, and is provided with
a connection flow path that connects a hole on an inner side in a radial direction among the two holes with a hole on an outer side in the radial direction among the two holes in an adjacent overlapping section.

2. The vaned diffuser according to claim 1, wherein a ratio A/L of a length A of the connection flow path to a length L of the overlapping section lies in a range of 0.5 or more and of less than 1.5.

3. A vaned diffuser comprising:
a partition plate;
a plurality of vanes provided on one surface side of the partition plate; and
a plurality of overlapping sections each formed to be sandwiched between the partition plate and adjacent vanes among the plurality of vanes, wherein
the partition plate has two holes in a direction orthogonal to each of the overlapping sections, and is provided with
a connection flow path that connects a hole on an inner side in a radial direction among the two holes with a hole on an outer side in the radial direction among the two holes in an adjacent every other overlapping section.

4. The vaned diffuser according to claim 1, wherein the connection flow path is composed of a pipe or a tube.

5. A blower comprising:
an impeller having a plurality of vanes disposed in a circumferential direction; and
the vaned diffuser according to claim 1 and provided on an outer circumferential side of the impeller, wherein
when the number of the vanes of the impeller is expressed as Zi and the number of the vanes of the diffuser is expressed as Zd, an angle between the vanes of the impeller: 360/Zi lies in a range of 0.9×2×360/Zd or more and of 1.1×3×360/Zd or less.

6. A fluid machine comprising the vaned diffuser according to claim 1.

7. The vaned diffuser according to claim 2, wherein the connection flow path is composed of a pipe or a tube.

8. The vaned diffuser according to claim 3, wherein the connection flow path is composed of a pipe or a tube.

9. A blower comprising:
an impeller having a plurality of vanes disposed in a circumferential direction; and
the vaned diffuser according to claim 2 and provided on an outer circumferential side of the impeller, wherein
when the number of the vanes of the impeller is expressed as Zi and the number of the vanes of the diffuser is expressed as Zd, an angle between the vanes of the impeller: 360/Zi lies in a range of 0.9×2×360/Zd or more and of 1.1×3×360/Zd or less.

10. A blower comprising:
an impeller having a plurality of vanes disposed in a circumferential direction; and
the vaned diffuser according to claim 3 and provided on an outer circumferential side of the impeller, wherein
when the number of the vanes of the impeller is expressed as Zi and the number of the vanes of the diffuser is expressed as Zd, an angle between the vanes of the impeller: 360/Zi lies in a range of 0.9×2×360/Zd or more and of 1.1×3×360/Zd or less.

11. A blower comprising:
an impeller having a plurality of vanes disposed in a circumferential direction; and
the vaned diffuser according to claim 4 and provided on an outer circumferential side of the impeller, wherein
when the number of the vanes of the impeller is expressed as Zi and the number of the vanes of the diffuser is expressed as Zd, an angle between the vanes of the impeller: 360/Zi lies in a range of 0.9×2×360/Zd or more and of 1.1×3×360/Zd or less.

12. A fluid machine comprising the vaned diffuser according to claim 3.

13. An electric blower comprising the vaned diffuser according to claim 1.

14. An electric blower comprising the vaned diffuser according to claim 3.
